(19) United States
(12) Patent Application Publication
(10) Pub. No.: US 2024/0385632 A1
(43) Pub. Date: Nov. 21, 2024

(54) METHOD AND APPARATUS FOR CONTROLLED SPLITTING OF FLUID FLOWS

(71) Applicant: PIVOTAL SYSTEMS CORPORATION, Fremont, CA (US)

(72) Inventors: Joseph R. Monkowski, Danville, CA (US); Tao Ding, Reno, NV (US); Jiuyi Cheng, Milpitas, CA (US); Sophia Shtilman, Sunnyvale, CA (US); Claudia Mendez, Fremont, CA (US); Igal Sokolov, Sunnyvale, CA (US); Joncarlo Avila, Dover, NH (US); Derek Brodie, Sunnyvale, CA (US)

(21) Appl. No.: 18/666,747

(22) Filed: May 16, 2024

Related U.S. Application Data
(60) Provisional application No. 63/467,863, filed on May 19, 2023.

(51) Int. Cl. G05D 7/06

(52) U.S. Cl. CPC G05D 7/0664

(57) ABSTRACT

A method and apparatus for the controlled splitting of a fluid flow into multiple channels, where an input command specifies the flow in each channel as a percentage of the total flow. The flow in each channel is controlled by a valve capable of moving to a specified position, where the position is determined as a function of the specified percentage, the pressure upstream of the valve, and the pressure downstream of the valve.

### RELATED APPLICATIONS

This application claims priority benefit from U.S. Provisional Application 63/467,863, filed on May 19, 2023, the disclosure of which is incorporated herein by reference in its entirety.

### BACKGROUND

Controlling the mass flow rate of a fluid is important for many industrial processes. In the case of the semiconductor industry, the mass flow rate must be especially accurate, because deviations of only several percent can lead to process failures. Once the mass flow rate of the fluid is established, which is typically accomplished with a mass flow controller (MFC), it is often desirable to split the flow of one or more MFCs into multiple flows, where the composition of all flows is identical, but the flow rates of the multiple flows are controlled to desired ratios. In the semiconductor industry, these ratios must be highly accurate, and any desired change in the flow ratios must be accomplished very quickly.

The industry-standard flow splitter device is a flow ratio controller (FRC) containing one inlet for the incoming fluid and multiple outlets for the multiple controlled flows. Each of the outlets is referred to as a channel, and it is common to refer to, for example, a two-channel or three-channel FRC, depending on the number of outlets. At this time, the typical FRC used in the semiconductor industry is used to control gas flow, and contains 2, 3, or 4 channels.

Currently available FRCs typically use an MFC for controlling the flow in each channel, thus sometimes referred to as mass flow ratio controllers. Although MFCs are used to control gas flow, their use in an FRC is not ideal. In a standalone situation, the MFC is commanded to flow at a particular flow rate. This is the purpose for which the MFC was designed. In an FRC, the inlet flow rate is initially unknown; the command sent to the FRC is for a particular ratio of outlet flow rates, where the total flow rate is not part of the command, and it can change during the operation of the FRC. The coordination among the MFCs to obtain the desired outlet flow ratios is not a straightforward task, and can take multiple seconds to accomplish.

With the semiconductor industry moving to shorter and more precise processes, transition times of multiple seconds can impact the quality of the process. The industry needs a flow splitting approach where the transitions can be made in times less than one second.

### SUMMARY

The following summary of the disclosure is included in order to provide a basic understanding of some aspects and features of the invention. This summary is not an extensive overview of the invention and as such it is not intended to particularly identify key or critical elements of the invention or to delineate the scope of the invention. Its sole purpose is to present some concepts of the invention in a simplified form as a prelude to the more detailed description that is presented below.

Embodiments of the present invention relate to the splitting of fluid flows into two or more channels according to a command that specifies the ratio of the flows in each channel, typically stated as a percentage of flow in each channel, where the total of the channels equals 100%. Embodiments of the present invention provide for transition times of one second or less to change ratios or to attain accurate flow after a change in the total fluid flow at the inlet. In these embodiments, the flow in each channel is controlled by a valve that is able to be opened to a particular position specified by a look-up table, graph, mathematical equation, etc. Each channel has a pressure sensor downstream of the valve that measures and reports the downstream pressure, and the upstream pressure is provided by a pressure sensor on the inlet that is common to all channels. The ratio of flows through the different channels is established by (1) determining the required positions of each valve for the required flow ratios, and (2) moving the valves to those positions.

Disclosed embodiments provide a system for splitting inlet fluid flow into multiple outlet flows comprising: an inlet for receiving the inlet fluid flow; an inlet pressure sensor positioned in the inlet, coupled to the fluid flow, that measures the inlet pressure and generates inlet pressure signal; two or more flow lines connected to the inlet; a plurality of controllable valves, each positioned in one of the flow lines and each able to be controlled independently to a desired position; a plurality of outlet pressure sensors, each positioned downstream of each of the controllable valves, that measures the downstream pressure and generates an outlet pressure signal; a controller receiving a ratio signal, the inlet pressure signal and the outlet pressure signal, and determining therefrom for each of the controllable valves a required valve position for various combinations of fluid flows and inlet pressure, and sending a control signal to each of the controllable valves to assume the required valve position.

According to disclosed aspects, a system for splitting inlet fluid flow into multiple outlet flows is provided, comprising: an inlet for receiving the inlet fluid flow; an inlet pressure sensor positioned in the inlet, coupled to the fluid flow, that measures the inlet pressure and generates inlet pressure signal; two or more flow lines connected to the inlet; a plurality of controllable valves, each positioned in one of the flow lines and each able to be controlled independently to a desired position; and, a controller receiving a ratio signal and the inlet pressure signal, and determining therefrom for each of the controllable valves a required valve positions for various combinations of fluid flows and inlet pressure, and sending a control signal to each of the controllable valves to assume the required valve position.

Various additional objects, features and advantages of embodiments in accordance with the present invention can be more fully appreciated with reference to the detailed description and accompanying drawings that follow.

### BRIEF DESCRIPTION OF THE DRAWINGS

The accompanying drawings, which are incorporated in and constitute a part of this specification, exemplify the embodiments of the present invention and, together with the description, serve to explain and illustrate principles of the invention. The drawings are intended to illustrate major features of the exemplary embodiments in a diagrammatic manner. The drawings are not intended to depict every feature of actual embodiments nor relative dimensions of the depicted elements and are not drawn to scale.

FIG. 1 shows a three-channel flow splitter of the prior art.

FIG. 2 shows a simplified view of an apparatus in accordance with an embodiment of the present invention, while FIG. 2A illustrates an apparatus in accordance with another embodiment and FIG. 2B is a flow chart of a process according to an embodiment.

FIG. 3 is a graphical representation of key parameters recorded during operation of an apparatus in accordance with embodiment of the present invention, while FIG. 3A is a flow chart of a process according to an embodiment.

### DESCRIPTION

Embodiments of the inventive flow splitting controller and method will now be described with reference to the drawings. Different embodiments or their combinations may be used for different applications or to achieve different benefits. Depending on the outcome sought to be achieved, different features disclosed herein may be utilized partially or to their fullest, alone or in combination with other features, balancing advantages with requirements and constraints. Therefore, certain benefits will be highlighted with reference to different embodiments but are not limited to the disclosed embodiments. That is, the features disclosed herein are not limited to the embodiment within which they are described, but may be “mixed and matched” with other features and incorporated in other embodiments, even if such are not explicitly described herein.

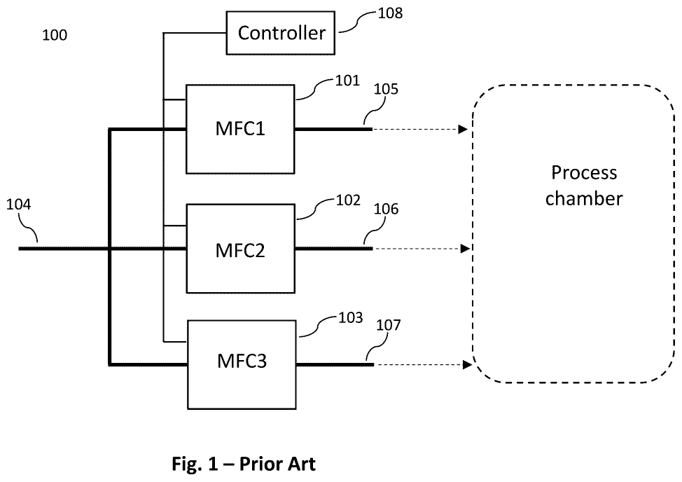

FIG. 1 is a simplified view of the prior art. Each channel of the flow splitter 100 contains an MFC 101, 102, and 103, which controls the flow in that channel. In a typical application in the semiconductor industry, the flow splitter is installed on a process tool, such as a plasma etcher or chemical vapor deposition (CVD) tool, just downstream of the group of flow controllers that control the flows of the individual gases. The gas mixture flowing from the group of individual flow controllers enters the flow splitter at the inlet 104. The process tool sends a setpoint command to the flow splitter controller 108 specifying the ratios or percentages of flows required in the channels 105, 106 and 107. The flow splitter controller has no information regarding the total flow coming into the inlet 104. The difficulty with the prior art is that the MFCs are designed to receive a setpoint command for a desired flow, not a ratio. Consequently, the flow splitter controller must adjust the flow setpoint command to each MFC such that the total flow is split into the required ratios. Since the required flows are not known initially, this is an iterative process, and since the MFCs typically require a minimum of 0.5 second for their flow sensors to obtain an accurate reading, the total process to achieve stable flows at the correct ratios can take multiple seconds.

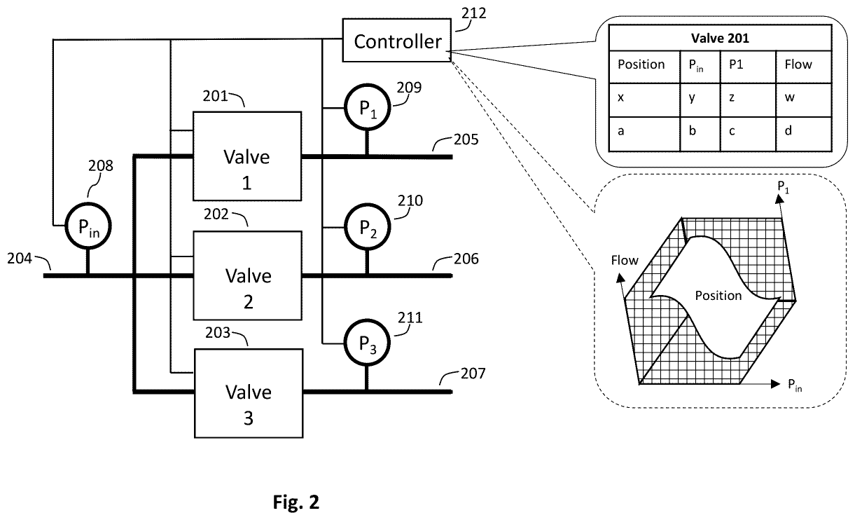

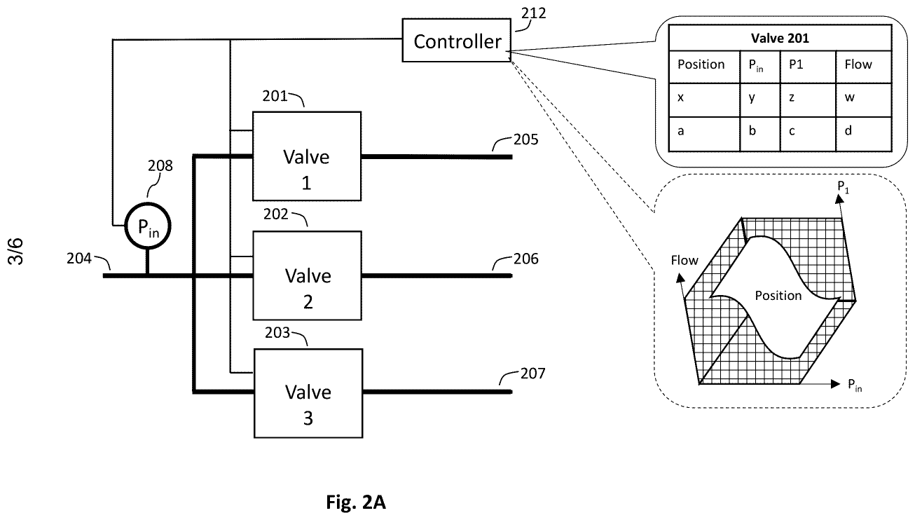

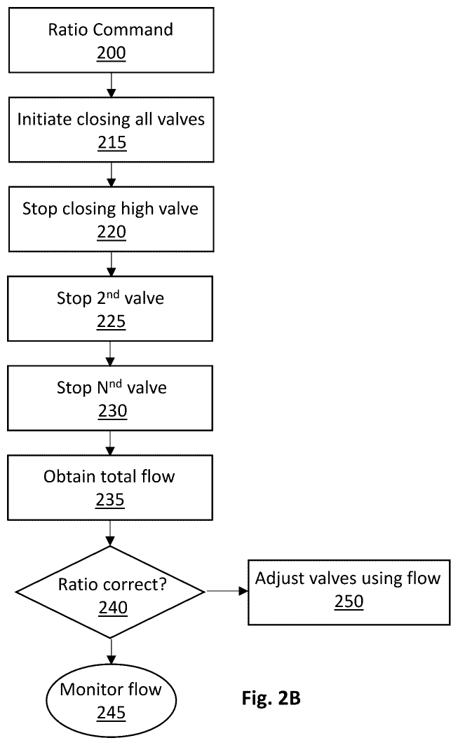

FIG. 2 is a simplified view of an embodiment of an apparatus in accordance with the present invention. This is an example of a three-channel flow splitter. The flow splitter controller 212 is continually reading the pressure signals of pressure sensors 208, 209, 210, and 211. The controller also commands the required positions for valves 201, 202, and 203. As exemplified by the solid-line callout in FIG. 2, each of the valves has its own position reference, e.g., a lookup table, which is contained in the memory of the controller, that specifies the required valve position for a given combination of upstream pressure, downstream pressure, and required flow. Since the total flow is not known when the ratio or percentage setpoint command is first sent by the process tool, determining the required valve positions for the commanded ratios can require an iterative process, but compared to the situation with the prior art, in this case, both the valve position and the pressure reading are established within milliseconds, providing information on actual flow much faster than in prior art devices, allowing the entire stabilization to the new total flow to occur in one second or less. If the total flow remains constant and the commanded ratio changes, that change can be made with a simple movement of the valves according to reading from the position reference for each valve. Since, after the iterative process described above, the total flow becomes known by adding the flow values from the position reference, the required flow for each channel with the new ratios or percentages can be quickly calculated, and with use of the respective lookup tables, each valve can be quickly moved to its required position.

For a typical flow splitter used for semiconductor wafer processing, the operating range of inlet pressures and downstream pressures will be specified. Construction of the lookup table for each individual valve then involves measuring the flows for various inlet and downstream pressures within the operating range while the valve is moved to different positions within its operating range. The number of points to measure for each of these variables will depend on the desired accuracy.

As an alternative to a lookup table, an equation or multidimensional graph could be used to determine the required valve position, as exemplified by the dash-line callout in FIG. 2. Most likely, this equation or graph will be empirically determined from data gathered in a manner similar to that described above for the lookup table.

In some applications, the downstream pressure might be known ahead of time. A typical example would be if the downstream pressure is determined by a process chamber, where the pressure inside the process chamber is very close to vacuum. In this case, the required positions of the valves can be determined with measurement of only the upstream inlet pressure.

If it is known ahead of time that the flow splitter will be used only in applications where the downstream pressure is known, then it is possible to save cost by eliminating the downstream pressure sensors, resulting in a flow splitter illustrated in FIG. 2A. In such a case, the values for outlet (i.e., channel) pressure is set as the process chamber pressure.

With the disclosed embodiments, a system for splitting a fluid flow into multiple flows is provided, comprising: an inlet for receiving the fluid flow; a pressure sensor in the inlet, coupled to the fluid flow, that measures the inlet pressure; two or more flow lines connected to the inlet; a valve in each of the flow lines able to be controlled to a desired position; and a means to determine for each valve the required valve positions for various combinations of fluid flow and inlet pressure. The position of each valve can be adjusted such that the flows in each of the flow lines are consistent with a setpoint command delivered to the system defining the desired ratio or percentages of flows.

It should be noted that the arrangements illustrated in FIGS. 2 and 2A do not require temperature measurement. Conversely, MFCs employ thermodynamic principles to derive mass flow rates, and rely on high temperature coefficient of resistance wires as sensor to measure the temperature differential (ΔT=T₂-T₁) across a heater mounted on the side stream. Thus, an MFC requires a steady flow of gas through the side stream, which prolongs the time it takes to set the MFC to the desired flow rate. Conversely, since the system of FIGS. 2 and 2A do not require temperature measurements and instead relies on the position reference, the set time is much faster than using MFCs. Moreover, the initial position of each valve can be determined by reference to the position reference without knowledge of the total inlet flow.

In one embodiment of the invention, the adjustment of the valve positions is carried out with the following steps, with reference to FIG. 2B:
1. The process tool establishes a flow of gas into the inlet of the flow splitter, and at the same time in step 200 commands the flow splitter with a setpoint of required ratios of the channels.
2. In step 215 the flow splitter controller commands all the valves, which are typically normally-open (NO) valves, to close to a certain preset position, which is typically in the range of about 80 to 95% of their maximum open position, but it could be outside of this range. The purpose of this step is to leave some margin for movement upward (i.e., opening) with the valve position if needed. (If the valves are normally closed valve, the command is to open and the process mirrors the process described with respect to normally open valves).
3. At 220, the valve with the largest required opening (highest flow) as determined from the required ratios, reaches its preset position and stays in that initial preset position of about 80 to 95% of its maximum open position, while all other valves receive a command from the controller to continue to close beyond the initial preset position. The flow through the first valve can now be determined using the position reference, e.g., lookup table.
4. As the valves continue to close, the flow through the second highest-flow valve is determined using the position reference and the ratio of its flow to the highest-flow valve is continuously calculated until the desired ratio is reached. At step 225 the second highest-flow valve reaches its correct opening value so that the ratio of the second-highest and the highest flow valves is reached, and the motion of the second-highest valve is stopped. Once the valve with the largest required opening and the valve with the second-largest required opening are in the correct flow ratio, then they remain in their positions while the other valve or valves (depending on the number of channels) continue to close, and each N valve is stopped when it reaches a position wherein its flow ratio to the highest flow valve is reached at 230. While they are closing, the ratio between the first two valves can change slightly, and so the valve with the second largest opening will need to be adjusted, but this adjustment will be very small. This pattern may be repeated until all valves are adjusted to their required flow ratios. At this point, the total flow can be calculated at 235 from the value of all of the valves with reference to the position reference, e.g., adding all the flows of the values as indicated by the look-up table.
5. At 240 it is checked whether the flow ratios are correct and, if so, at 245 the process proceeds to monitor the flow for any changes. Conversely, if the flow ratios are not proper, at 250 an iterative process may be used to adjust the ratios.

If at 245 the total flow changes, the valve positions might need to be adjusted, but the adjustment will be small.

If the required ratio changes, the valves will need to be moved accordingly, but this change can be very fast since the total flow is already known, and the required positions can be determined directly from the lookup tables.

Thus, a method for splitting a fluid flow in a flow splitter is provided, comprising: constructing a position reference for each valve in the flow splitter by measuring inlet pressure and fluid flow through the valve for multiple valve positions, and storing the position reference in a controller; receiving at the controller a signal indicative of desired flow ratio of fluid flow in multiple channels of the flow splitter; measuring pressure at an inlet of the flow splitter; using the pressure at the inlet and the position reference for each valve to send signal from the controller to drive each valve to a position according to the desired flow ratio.

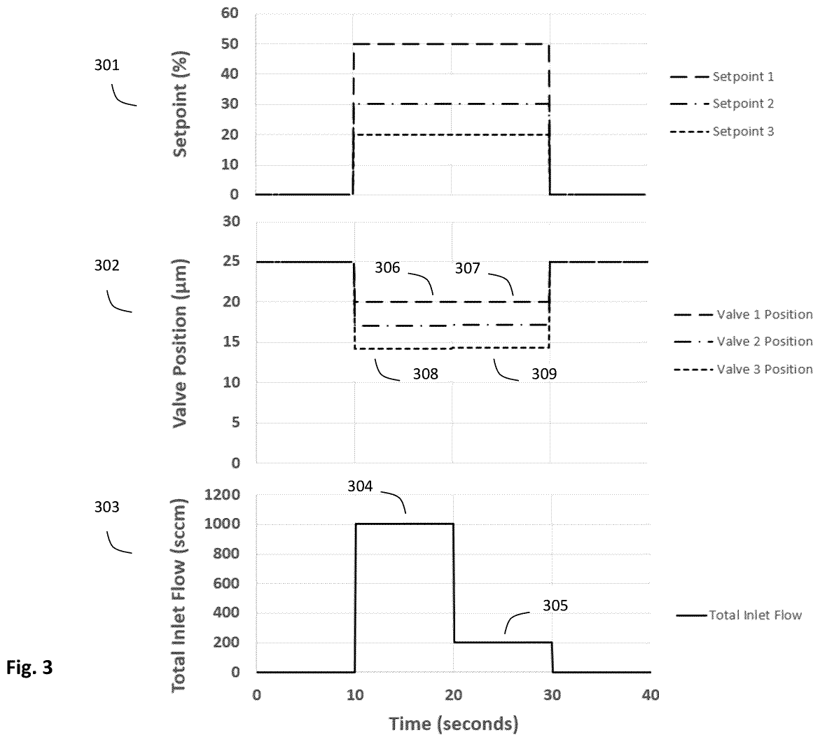

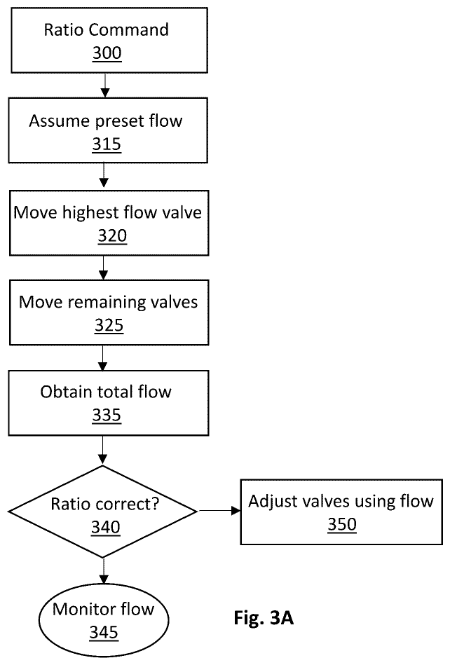

One of the big advantages of the present invention is the insensitivity of required valve position to total flow. Also, since inlet pressure changes with total flow, the valve position in the present invention is also insensitive to inlet pressure. FIG. 3 shows three graphs describing the operation of an embodiment of the present invention. The top graph 301 shows the commanded setpoint for each of the three channels, the middle graph 302 shows the valve position for each of the three channels, and the bottom graph 303 shows the total flow of gas, according to an arbitrary example, into the inlet of the three-channel flow splitter.

In this embodiment, as the total inlet flow changes, the valve with the largest flow remains at a constant position 306, 307 while the other valves are adjusted to maintain the commanded setpoints. As can be seen, when the flow changes from 1000 sccm (standard cubic centimeters per minute) 304 to 200 sccm 305, the positions of the other valves change very little. Valve 3 shows the largest change, but this change is no more than about 1% as the flow changes from 1000 sccm 308 to 200 sccm 309.

This insensitivity to total inlet flow can be used to advantage with the choice of a starting position for the flow splitter. When the process tool commands a setpoint for each of the channels, the flow from the upstream flow controllers will most likely be just beginning. Consequently, the flow splitter will receive the setpoint command before the flow gets to the flow splitter. Such a condition is untenable for an MFC-based flow splitter, since the MFC cannot determine the flow and set a position without gas flowing and generating thermal differential. Fortunately for the present invention, this uncertainty is not a problem using the described embodiments. Until the flow increases sufficiently to allow measurement and control, the flow splitter can assume a certain, predetermined total inlet flow, and the splitting of the flows will be very close to the accurate percentages. Typical total flows that can be assumed are the maximum specified flow, or 50% of the maximum specified flow, or any other value determined reasonable by one skilled in the art. For example, if a three-channel flow splitter has a maximum flow of 1000 sccm for each channel, typical assumed initial total flows would be 3000 sccm or 1500 sccm.

With this approach of an assumed initial flow, an embodiment of the present invention can carry out the following steps:
1. The process tool initiates a flow of gas into the inlet of the flow splitter, and at the same time commands the flow splitter with a setpoint of required ratios or percentages 300.
2. Until the flow into the flow splitter is sufficiently large to allow an accurate measurement of the flow in each of the channels, and consequently the total flow, the flow splitter assumes a total flow equal to a predetermined value 315.
3. The valve with the largest flow moves to a position that is typically in the range of about 80 to 95% of its maximum open position, but it could be outside of this range, 320. The purpose of this step is to leave some margin for movement upward with the valve position if needed.
4. Since the total flow is a preset value (although not necessarily the actual value), and the percentages for each of the channels are known, and the position of the valve in the channel with the largest flow is known, then the position of each of the remaining valves can be quickly determined. The valves then move to their required positions 325.
5. Once the flow into the flow splitter increases to a level sufficient to allow an accurate measurement of the flow in each channel 335, the determination of the required valve positions is carried out using the actual flow at 340. If the ratio is correct the controller continues to monitor the flow at 245, while if not, an iterative process is used to adjust the valve to arrive at the correct ratio.

When the total inlet flow is very low, the pressure signals Pin will be very low, and the signal-to-noise ratio will be too low to make an accurate measurement. During this time the system uses the assumed predetermined or preset total flow value. Once the flow rises to a sufficient level for the pressure signals to provide a good signal-to-noise ratio, e.g., passes a preset threshold, then the flow splitter is able to determine the flow in each channel and establish the correct flow percentages by the iterative correction process.

Another feature enabled by the insensitivity to total flow is the capability to maintain accurate flows even if the total flow decreases below that value where accurate total flow measurements can be made. The reason for this inability to measure very low flows accurately is because the pressure signals are very low, which means their signal-to-noise level is very low. For example, if the minimum total flow at which a good measurement can be made is 20 sccm, then if the total flow decreases below 20 sccm, the flow splitter can assume the total flow is 20 sccm, and can control the valves accordingly, changing the valve positions if the setpoint changes, or if, for example, the downstream pressure changes. If the total flow increases above 20 sccm, then normal operation will resume.

Another feature of the present invention is the capability to fix the positions of the valves when the percentages are unchanging. This can produce more stable flows, and will be accurate even if the total inlet flow changes.

With the disclosed embodiment, a method for constructing a flow splitter is provided, comprising: fabricating an inlet configured for receiving fluid flow; attaching a pressure sensor to the inlet; fabricating a plurality of flow channels, each in fluid communication with the inlet; inserting an electrically controlled valve in each of the plurality of flow channels; electrically connecting the pressure sensor and each of the electrically controlled valves to a controller; constructing a position reference within the controller for each of the electrically controlled valves, wherein the position reference indicates a relationship between valve position, upstream pressure, and fluid flow through the electrically controlled valve.

What is claimed is:

1. A system for splitting inlet fluid flow into multiple outlet flows comprising:
an inlet for receiving the inlet fluid flow;
an inlet pressure sensor positioned in the inlet, coupled to the fluid flow, that measures the inlet pressure and generates inlet pressure signal;
two or more flow lines connected to the inlet;
a plurality of controllable valves, each positioned in one of the flow lines and each able to be controlled independently to a desired position;
a controller receiving a ratio signal and the inlet pressure signal, and determining therefrom for each of the controllable valves a required valve position for various combinations of fluid flows and inlet pressure, and sending a control signal to each of the controllable valves to assume the required valve position.

2. A system of claim 1, further comprising a plurality of outlet pressure sensors, each positioned downstream of each of the controllable valves, that measures the downstream pressure and generates an outlet pressure signal.

3. A system of claim 1, wherein the controllable valves are normally-open valves.

4. A system of claim 1, wherein the controllable valves are normally-closed valves.

5. A system of claim 1, wherein the controller includes a position reference for each controllable valve, the position reference associates a valve position, an inlet pressure and a flow rate through the valve.

6. A system of claim 1, wherein the position reference is one of: a look-up table, an equation, or a multidimensional graph.

7. A system of claim 1, wherein the fluid is a gas.

8. A system of claim 1, wherein the fluid is a liquid.

9. A system according to claim 1, wherein the position of each valve can be adjusted such that the flows in each of the flow lines are consistent with a setpoint command delivered to the system defining the desired ratio or percentages of flows.

10. A system according to claim 1, wherein the position of a controllable valve controlling the largest flow among the plurality of controllable valves is set to a predetermined value.

11. A system according to claim 10, wherein the predetermined value is between 80% and 95% of the maximum valve position.

12. A system according to claim 10, wherein the predetermined value is 50% of the maximum valve position or greater.

13. A system for splitting a fluid flow into multiple flows comprising:
an inlet for receiving the fluid flow;
a pressure sensor in the inlet, coupled to the fluid flow, that measures the inlet pressure;
two or more flow lines connected to the inlet;
a valve in each of the flow lines able to be controlled to a desired position;
a means to determine for each valve the required valve positions for various combinations of fluid flow and inlet pressure.

14. A system according to claim 13, wherein the position of each valve can be adjusted such that the flows in each of the flow lines are consistent with a setpoint command delivered to the system defining the desired ratio or percentages of flows.

15. In a flow splitter having an inlet and multiple flow channels, each of the multiple flow channels having a valve, a method for splitting a fluid flow into multiple fluid flows, the method comprising:
reading the pressure upstream and downstream of the valve in each of the flow channels;
reading the setpoint command that specifies the ratio or percentage flow for each of the flow channels; and
establishing the required valve position in each flow channel to establish the flow ratio or percentage specified by the setpoint.

16. The method of claim 15, wherein the required valve position in each flow channel is determined from a lookup table.

17. The method of claim 16, wherein the lookup table is established by measuring the flow in each channel as a function of valve position, upstream pressure, and downstream pressure.

18. The method of claim 15, wherein the required valve position in each flow channel is determined from an equation or multidimensional graph.

19. The method of claim 15, wherein establishing the required valve position in each flow channel begins by setting the valve with the largest flow percentage to a predetermined position.

20. The method of claim 19, wherein establishing the required valve positions for the other valves is done by assuming a certain total inlet flow.

21. The method of claim 15, wherein sometime after the required valve position in each flow channel is established, the valves are held at fixed positions for a period of time.

22. The method of claim 21, wherein the period of time is until the setpoint changes.

23. In a flow splitter having an inlet and multiple flow channels, each of the multiple flow channels having a valve, a method for splitting a fluid flow into multiple fluid flows, the method comprising:
reading the pressure upstream of the valves;
reading the setpoint command that specifies the ratio or percentage flow for each of the flow channels; and
establishing the required valve position in each flow channel to establish the flow percentage specified by the setpoint.
